(19) United States
(12) Patent Application Publication
(10) Pub. No.: US 2011/0055355 A1
(43) Pub. Date: Mar. 3, 2011

(54) APPLICATION DOWNLOADING METHOD, APPLICATION PROVIDING METHOD, USER TERMINAL USING THE SAME

(75) Inventors: Min-cheol LEE, Seoul (KR); Nam-geol LEE, Seoul (KR); Woo-yong CHANG, Yongin-si (KR); Seung-dong YU, Osan-si (KR); Se-jun PARK, Yongin-si (KR); Min-jeong MOON, Seongnam-si (KR)

(73) Assignee: SAMSUNG ELECTRONICS CO., LTD., Gyeonggi-Do (KR)

(21) Appl. No.: 12/860,091

(22) Filed: Aug. 20, 2010

(30) Foreign Application Priority Data
Aug. 21, 2009 (KR) 2009-0077555
Sep. 13, 2009 (KR) 2009-0086206
Aug. 9, 2010 (KR) 2010-0076505

(51) Int. Cl. G06F 15/16

(52) U.S. Cl. 709/219

(57) ABSTRACT

An application downloading method, an application providing method, and a user terminal using the same. According to the application downloading method, a user terminal transmits user terminal information to a server, receives an application list generated based on the user terminal information, and display the received application list on a screen. Accordingly, the user can download a desired application more easily and simply.

### CLAIM OF PRIORITY

This application claims the benefit under 35 U.S.C. §119 (a) from Korean Patent Application No. 2009-0077555 filed on Aug. 21, 2009, No. 2009-0086206 filed on Sep. 13, 2009, and No. 2010-0076505 filed Aug. 9, 2010, in the Korean Intellectual Property Office, the entire disclosures of which are incorporated herein by reference in their entirety.

### BACKGROUND OF THE INVENTION

1. Field of the Invention

The present disclosure relates generally to an application downloading method, an application providing method, and a user terminal using the same. More particularly, the present invention relates to an application downloading method and an application providing service by which a user terminal downloads an application from a server, and a user terminal using the same.

2. Description of the Related Art

Recently, application stores for selling applications used in a mobile apparatus online have become popular. A representative example of the application store is the App Store of Apple Inc.

Accordingly, a user gets access to an application store on the Internet using his/her own mobile apparatus, makes payment for Internet commerce, and then directly downloads a desired application. That is, the user can download an application using his/her own mobile apparatus.

However, since the application store provided on the Internet sells a large amount of applications, the user needs a significant amount of time to search for a desired application. Also, the user may not know what application is applicable to the user's apparatus.

The user wishes to download a desired application with ease. Accordingly, there is a need in the art for a method of downloading an application desired by a user easily and simply.

### SUMMARY OF THE INVENTION

A first exemplary aspect of the present invention provides an application downloading method and an application providing method, in which a user terminal sends user terminal information to a server, receives an application list generated based on the user terminal information, and displays the received application list on a screen, and a user terminal using the same.

Another exemplary aspect of the present invention provides an application providing method in which a server receives user terminal information from a user terminal, generates an application list based on the user terminal information, and sends the application list to the user terminal.

According to an exemplary aspect of the present invention, there is provided an application downloading method of a user terminal which downloads an application from a server, the method preferably including: sending at least one of user terminal information, network information, service provider information, and user information to the server, receiving an application list which is generated based on the at least one of the user terminal information, the network information, the service provider information, and the user information, and displaying the application list on a screen.

The user terminal information may include, for example, at least one of a manufacturer, a model name, a definition, CPU information, storage information, storing capacity, and information of presence/absence of a touch screen of the user terminal.

The network information may be information relating to a data rate of a network connected between the user terminal and the server.

The service provider information may be information relating to an application that is provided by a service provider of the user terminal.

The user information may include, for example, at least one of a buying history of a user of the user terminal and preference information of the user.

The sending of terminal information may include giving priorities to properties included in the at least one of the user terminal information, the network information, the service provider information, and the user information.

The sending of terminal information may include adding flags representing priorities to properties included in the at least one of the user terminal information, the network information, the service provider information, and the user information.

The displaying of the application list on a screen may include displaying the application list on the screen according to properties included in the at least one of the user terminal information, the network information, the service provider information, and the user information.

According to another exemplary aspect of the present invention, a user terminal which downloads an application from a server, preferably includes: a network interface for accessing the server over one of a plurality of networks, a display unit for displaying an image, and a controller for controlling the network interface to send at least one of user terminal information, network information, service provider information, and user information to the server and receive an application list which is generated based on the at least one of the user terminal information, the network information, the service provider information, and the user information, and for controlling display of the application list on a screen.

The user terminal information may include, for example, at least one of a manufacturer, a model name, a definition, CPU information, storage information, storing capacity, and information relating to presence/absence of a touch screen of the user terminal.

The network information may be information relating to a data rate of a network connected between the user terminal and the server.

The service provider information may be information relating to an application that is provided by a service provider of the user terminal.

The user information may include, for example, at least one of a buying history of a user of the user terminal and preference information of the user.

The controller may control giving priorities to properties included in the at least one of the user terminal information, the network information, the service provider information, and the user information, and sending the at least one information.

The controller may control adding flags representing priorities of properties included in the at least one of the user terminal information, the network information, the service provider information, and the user information, and sending the at least one information.

The controller may control displaying the application list on the screen according to properties included in the at least one of the user terminal information, the network information, the service provider information, and the user information.

According to yet another exemplary aspect of the present invention, there is provided an application providing method of a server which provides an application to a user terminal, the method including: receiving at least one of user terminal information, network information, service provider information, and user information from the user terminal, extracting at least one application from pre-stored applications, based on the at least one of the user terminal information, the network information, the service provider information, and the user information, and generating an application list using the extracted application and sending the application list to the user terminal.

The extracting may include, for example, extracting at least one application executable at the user terminal from the pre-stored applications based on the user terminal information.

The extracting may include, for example, extracting at least one application downloadable within a specific time according to a data rate of the network based on the network information.

The extracting may include, for example extracting at least one application provided by a service provider of the user terminal based on the service provider information.

The extracting may include, for example, extracting at least one application according to a buying history and preference of the user based on the user information.

The application providing method according to the present invention may further include storing the buying history and the preference of the user, and the extracting may include extracting at least one application according to the stored buying history and a preference of the user.

The application providing method may also further include changing at least one of a condition for the user terminal information, a condition for the network information, and a condition for the service provider information to extract an application in the extracting operation.

According to yet another exemplary aspect of the present invention, a server which provides an application to a user terminal, preferably includes: a network interface for accessing the user terminal over one of a plurality of networks, and a controller for controlling the network interface to receive at least one of user terminal information, network information, service provider information, and user information, for extracting at least one application from stored applications based on the at least one of the user terminal information, the network information, the service provider information, and the user information, for generating an application list using the extracted application, and for sending the application list to the user terminal.

The controller may extract at least one application executable at the user terminal from the stored applications based on the user terminal information.

The controller may extract at least one application downloadable within a specific time according to a data rate of the network based on the network information.

The controller may extract at least one application that is provided by a service provider of the user terminal based on the service provider information.

The controller may extract at least one application according to a buying history and preference of the user based on the user information.

The server may further include a data base unit for storing the buying history and the preference of the user, and the controller may extract at least one application according to the stored buying history and preference of the user.

The server may further include, for example, a storage unit for storing at least one of a condition for the user terminal information, a condition for the network information, and a condition for the service provider information to extract an application, and the controller may change at least one of the condition for the user terminal information, the condition for the network information, and the condition for the service provider information.

According to the many exemplary aspects of the presently claimed invention, since the application downloading method and the application providing method in which the user terminal transmits the user terminal information to the server, receives the application list generated based on the user terminal information, and displays the received application list on the screen, and the user terminal using the same are provided, the user can download the desired application more easily and simply than known heretofore.

In particular, since the application list that is suitable for the user terminal is received from the server, the user can avoid searching unnecessary applications when downloading the desired application.

### BRIEF DESCRIPTION OF THE DRAWINGS

These and/or other exemplary aspects of the present invention will become more apparent and more readily appreciated from the following description of exemplary embodiments thereof, with reference to the accompanying drawings, in which:

FIG. 1 is a flowchart of an application downloading method according to an exemplary embodiment of the present invention;

FIGS. 2A to 2H are views of a process of downloading a map application if a user terminal is a camera according to an exemplary embodiment of the present invention;

FIG. 3 is a block diagram of a user terminal 100 according to an exemplary embodiment of the present invention;

FIG. 4 is a view of a screen on which an application corresponding to a definition is displayed after an application corresponding to a model name is displayed according to an exemplary embodiment of the present invention;

FIG. 5 is a diagram of a data transmitting system according to an exemplary embodiment of the present invention;

FIG. 6 is a flowchart of an application providing method according to an exemplary embodiment of the present invention;

FIG. 7 is a diagram of an application filtering process according to an exemplary embodiment of the present invention;

FIG. 8 is a block diagram of a terminal according to an exemplary embodiment of the present invention; and

FIG. 9 is a block diagram of a server according to an exemplary embodiment of the present invention.

### DETAILED DESCRIPTION

A discussion will now be made herein below in detail regarding certain exemplary embodiments of the present invention, examples of which are illustrated in the accompanying drawings, wherein like reference numerals refer to the like elements throughout. The exemplary embodiments are described below to explain the present invention by referring to the figures.

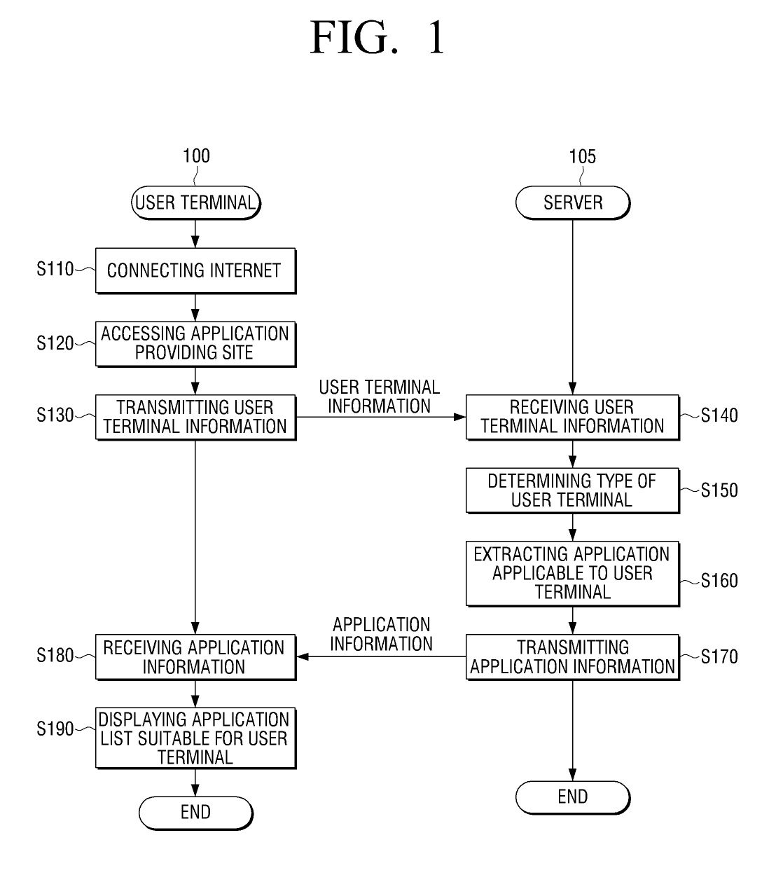

FIG. 1 is a flowchart of an application downloading method according to an exemplary embodiment of the present invention.

At (S110), a user terminal 100 is connected to Internet. The user terminal 100 may get access to the Internet through a wired LAN or a wireless network such as wireless LAN or WiBro.

After that, at (S120) the user terminal 100 gets access to a server 105 that provides an application providing site according to a user's manipulation. After getting access to the server 105 of the application providing site, at (S130) the user terminal 100 transmits user terminal information to the server 105.

The user terminal information recited herein refers to information indicating a specification property of the user terminal 100. More specifically, the user terminal information includes at least one of a model name, a definition, CPU information, storage information, a storing capacity, and information of presence/absence of a touch screen of the user terminal 100. The user terminal information may comprise, for example, metadata of the user terminal 100.

Also, the user terminal 100 may set priorities to the user terminal information and then transmit the user terminal information. For example, if a user wishes to set the priority to the model name, the user terminal 100 adds a priority flag to the model name information of the user terminal information and then transmits the user terminal information with the priority flag. Then, the server 105 extracts an application suitable for the user terminal 100 by preferably applying the model name.

As described above, if the user terminal 100 transmits the user terminal information to the server 105, then at (S140) the server 105 receives the user terminal information over the Internet. At (S150), the server 105 determines the type of the user terminal 100 or the property of the user terminal 100 based on the user terminal information.

At (S160), the server 105 extracts an application applicable to the user terminal 100 from among stored applications based on the determined type or property of the user terminal 100. For example, if the server 105 receives the model name as the user terminal information, the server 105 extracts an application executable at the corresponding model. If the server 105 receives the definition as the user terminal information, the server 105 extracts an application executable at the received definition.

At (S170), the server 105 transmits information relating to the extracted application to the user terminal 100. Then at (S180), the user terminal 100 receives the application information from the server 105.

At (S190), the user terminal 100 displays an application list suitable for the user terminal 100 on a screen using the received application information. At this time, the user terminal 100 may display the application list according to the properties included in the user terminal information. For example, the user terminal 100 may group the applications suitable for the model name into one group and display the group on the screen, or may display one group of applications suitable for the definition on the screen.

In addition, the user terminal 100 may give priorities to the properties of the user terminal information. For example, the user terminal 100 may display the applications suitable for the model name on the screen first and then display the applications suitable for the definition on the screen.

Through the above-described process, the user terminal 100 can identify the list of applications suitable for the user terminal 100 from the server 105, so that the user can find an application easily as he/she desires without displaying items that are not applicable/compatible with the user terminal.

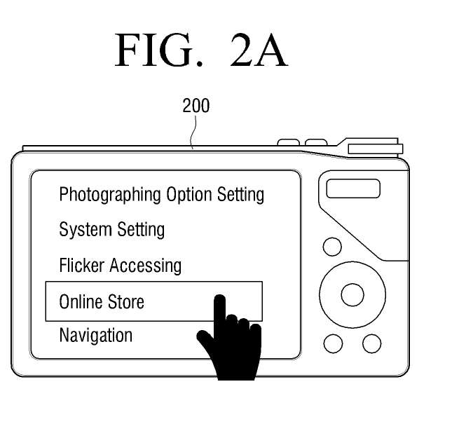

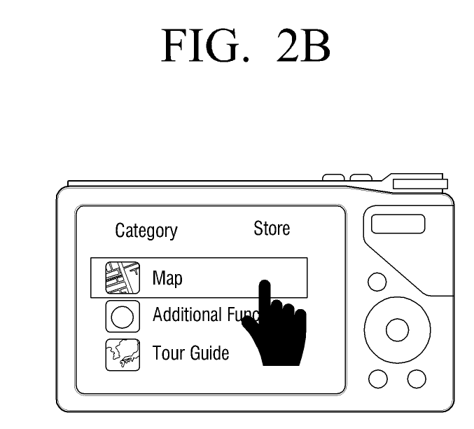

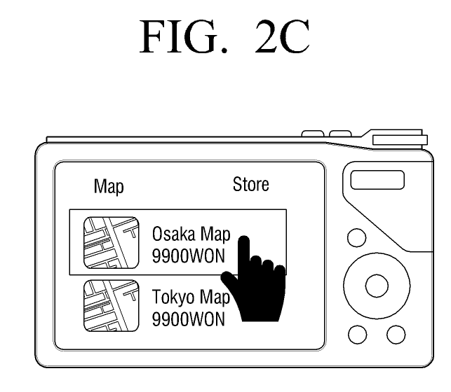

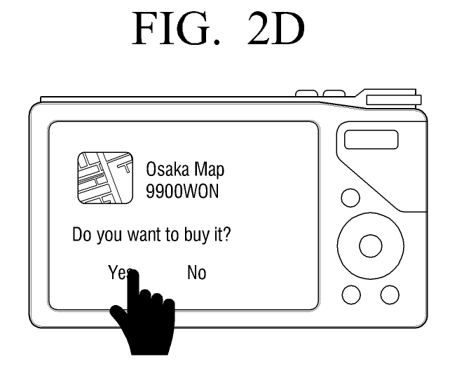

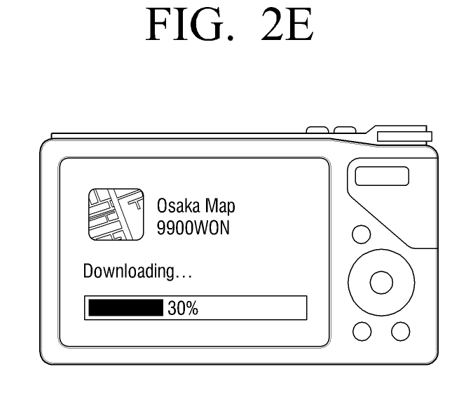

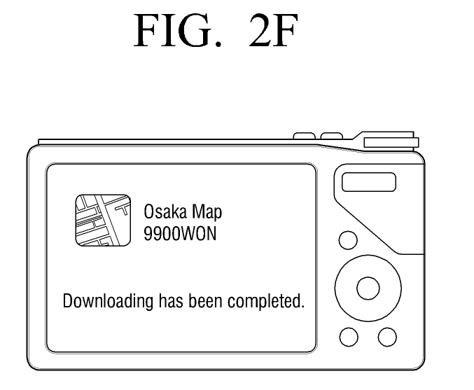

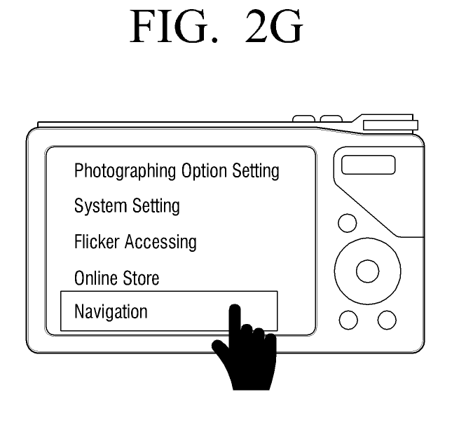

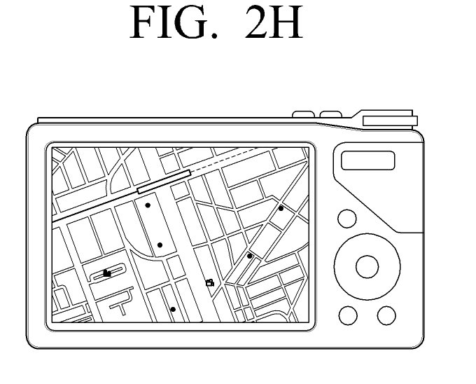

Hereinafter, a process of downloading a map application if the user terminal 100 is a camera will be explained with reference to FIGS. 2A to 2H. FIGS. 2A to 2H are exemplary views illustrating a process of downloading a map application if the user terminal 100 is a camera 200.

FIG. 2A is view of a display screen of the camera 200 on which a main menu is displayed. As shown in FIG. 2A, the main menu of the camera 200 includes an item ‘Online Store’. The item ‘Online Store’ functions as a link to get access to a site providing applications on the Internet. Therefore, if the user selects the item ‘Online Store’, the camera 200 gets access to the server 105 that provides an application providing site over the Internet. Then, the camera 200 transmits its own user terminal information to the server 105.

Then as shown in FIG. 2B, the camera 200 displays a category of applications provided by the online store on the display screen. The displayed category includes, for example, applications that are usable in the camera 200.

Now referring to FIG. 2C, if the user selects an item ‘Map’ from the category, the camera 200 displays a list of map applications that can be downloaded on the screen as shown. The map applications shown in FIG. 2C are non-limiting examples of map applications that are selected by the application providing server 105 as being suitable for the camera 200 with reference to the user terminal information of the camera 200. More specifically, the application providing server 105 may extract a map application suitable for the model of the camera 200. Also, the application providing sever 105 may extract a map application suitable for the definition of the camera 200.

As described above, the camera 200 receives the list of application suitable for the use from the server 105, and displays the list of applications on the screen as shown in FIG. 2C. Accordingly, the user can select an application executable at the camera 200 with ease.

If the user selects an item ‘Osaka Map’ in FIG. 2C, then as shown in FIG. 2D, a message asking a user of whether or not the user will buy the application ‘Osaka Map’ is displayed as shown. If the user selects ‘yes’, a buying procedure is performed. Then, when the affirmative response regarding a purchase is entered in FIG. 2D, as shown in FIG. 2E, the selected application is downloaded to the user terminal.

As shown in FIG. 2F, once the downloading is completed, a message indicating that the downloading has been completed is displayed on the screen.

Now referring to FIG. 2G, if the user selects an item ‘Navigation’ from the main menu after having downloaded the application ‘Osaka Map’, the user can use the application ‘Osaka Map’ by executing it on the navigation device as shown in FIG. 2H.

As described above, by transmitting the user terminal information to the server 105, the camera 200 receives the list of application suitable for the use therein and displays the list. Therefore, the user checks only the application information suitable for the camera 200 from the online store using the camera 200, and finds and downloads a desired application rapidly.

In this exemplary embodiment of the present invention, the user terminal 100 is the camera 200. However, the user terminal 100 may comprise many other types of apparatuses. More specifically, the user terminal 100 may be. for example. a mobile phone, a digital album, and a TV. Also, the suitable application is different according to the particular apparatus (mobile phone, digital album., etc.) that constitutes the user terminal 100.

For example, if the user terminal 100 comprises a mobile phone, an application suitable for the mobile phone may include a mobile bell sound, a mobile widget, and contents. If the user terminal 100 comprises a digital album, a suitable application may include a premium application, a widget, and famous artist's photos. Also, if the user terminal 100 comprises a TV, a suitable application may be a premium application and a moving picture file.

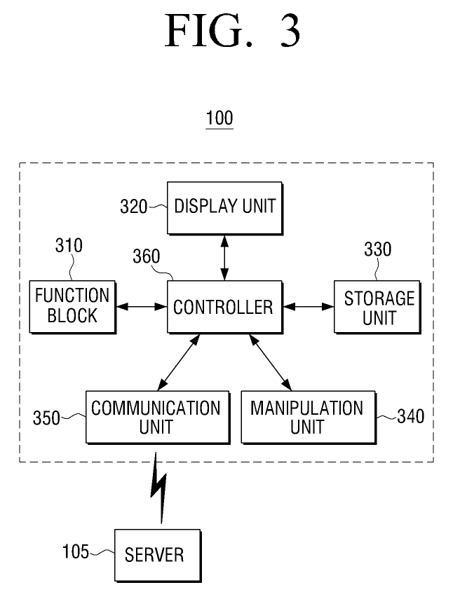

Hereinafter, the user terminal 100 will be explained in detail with reference to FIG. 3. FIG. 3 is a block diagram of the user terminal 100 according to an exemplary embodiment of the present invention. As shown in FIG. 3, the user terminal 100 preferably includes a function block 310, a display unit 320, a storage unit 330, a manipulation unit 340, a communication unit 350, and a controller 360.

With continued reference to FIG. 3, the function block 310 performs the original function of the user terminal 100. If the user terminal 100 comprises an MP3 player, the function block 310 performs the MP3 player function, and if the user terminal 100 comprises a portable multimedia player (PMP), the function block 310 performs the PMP function.

The display unit 320 displays an input image and displays a guide user interface (GUI). More specifically, the display unit 320 displays the screens as shown in FIGS. 2A to 2H, such as the main menu and the application list.

The storage unit 330 comprises a storage medium that stores a plurality of contents. The storage unit 330 may store a downloaded application. The storage unit 330 may be a hard disk or any type of a non-volatile memory.

The manipulation unit 340 receives a user's manipulation to input a specific command. For example, the manipulation unit 340 may include a button, a wheel, and a touch screen.

The communication unit 350 is communicably connected to the application providing server 105. The communication unit 350 transmits the user terminal information to the application providing server 105, and receives the application list from the application providing server 105. The communication unit 350 may be a wired communication module such as a wired LAN card, or a wireless communication module such as a wireless LAN or Bluetooth.

The controller 360 performs the operations illustrated in the flow chart of FIG. 1 and performs the processes of FIGS. 2A to 2H, so that the user terminal 100 can display the list of suitable applications received from the server 105.

More specifically, with continued reference to FIG. 3, the controller 360 controls the communication unit 350 to transmit the user terminal information to the application providing server 105 and receive the application list generated based on the user terminal information. The user terminal information recited herein refers to information indicating the specification property of the user terminal 100. More specifically, the user terminal information preferably includes at least one of a model name, a definition, CPU information, storage information, storing capacity, and information of presence/absence of a touch screen of the user terminal 100. The user terminal information may comprise metadata of the user terminal 100.

The controller 360 may give priorities to the user terminal information. For example, if the user wishes to give priority to the model name, the controller 360 adds a priority flag to the model name information of the user terminal information and transmits the user terminal information with the priority flag. Then, the server 105 extracts an application suitable for the user terminal 100 by applying the model name preferentially.

Also, the controller 360 controls the display unit 320 to display the application list on the screen. Also, the controller 360 controls the display unit 320 to display the application list according to the properties included in the user terminal information.

As described, by transmitting the user terminal information to the server 105, the controller 360 of the user terminal 100 receives the list of applications suitable for the use in the user terminal 100 and displays the list. Therefore, the user checks only the information of the applications suitable for the user terminal 100 from the online store using the user terminal 100, and finds and downloads a desired application rapidly.

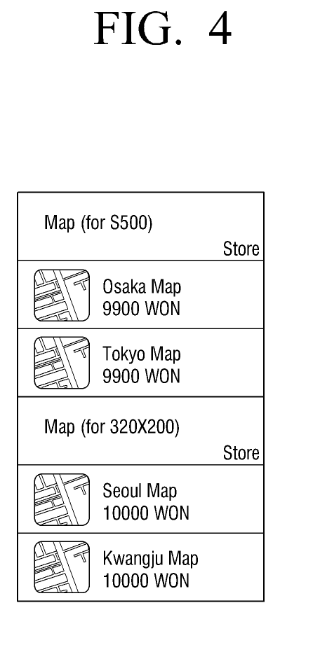

FIG. 4 is a view of a screen on which an application according to a definition is displayed after an application according to a model name is displayed according to an exemplary embodiment of the present invention. When the user gets access to an application providing site utilizing the user terminal 100, the user terminal 100 displays a list of applications on the screen as shown in FIG. 4.

The user terminal 100 in FIG. 4 has a model name ‘S500’ and a definition ‘320*200’. The user terminal 100 displays a list of map applications usable in the model name ‘S500’ preferentially and then displays a list of map applications applicable to the definition 320*200. That is, it can be seen that priority is given to the applications suitable for the model name of the user terminal 100. The priority may be given to what the user wants.

Therefore, the user can identify the list of applications suitable for use in the user terminal 100 simply by getting access to the application providing site as shown in FIG. 4.

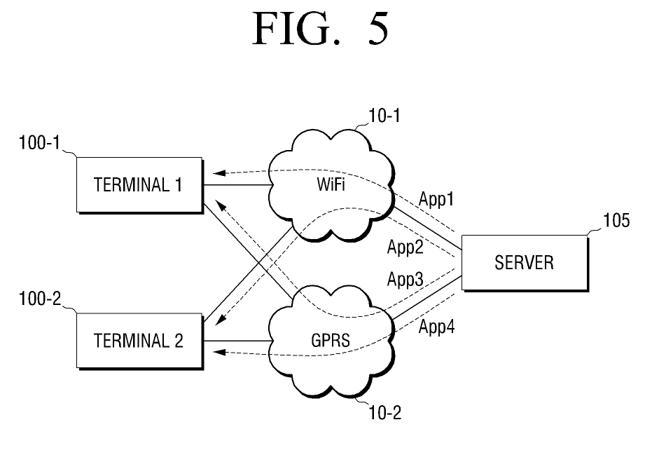

FIG. 5 is a diagram of a data transmitting system according to an exemplary embodiment. An application transmitting system according to an exemplary embodiment provides an application, which is created by a Contents Provider (CP) and stored to a server 200, to a terminal over a network.

As shown in FIG. 5, the application transmitting system includes a plurality of terminals 100-1 and 100-2, a plurality of networks 10-1 and 10-2, and a server 105.

The first terminal 100-1 and the second terminal 100-2 correspond to user terminals or clients, and can receive an applications stored to the server 105 by accessing the server 105 over the networks 10-1 and 10-2. Hence, a user of the user terminal can utilize the received application.

The first terminal 100-1 and the second terminal 100-2 send an application list to the server 105. The server 105 can select some items from the received application list and use the selected application. In order to acquire the application list optimized to itself, the first terminal 100-1 and the second terminal 100-2, transmit their respective user terminal information to the server 105 as well.

The server 105 stores applications, contents, and data created/generated by the CP, and sends the application list to the first terminal 100-1 or the second terminal 100-2 according to the request of the first terminal 100-1 or the second terminal 100-2. Herein, the CP creates or generates the application or the contents, and sends the created application or contents to the server 105 over the network 10-1 or 10-2 for storage by the server 105. A person of ordinary skill in the art understands and appreciates that the storage may be accessible by the server and is not necessarily within the server. In addition, the server could be one of several proxy servers that can provide content to the terminals.

The server 105 typically receives the request for the application list together with the user terminal information of the first terminal 100-1 or the second terminal 100-2 as stated above. Accordingly, the server 105 extracts applications optimized for the first terminal 100-1, or the second terminal 100-2, from the stored applications, and provides the list of the extracted applications to the first terminal 100-1 or the second terminal 100-2.

The user terminal information includes information relating to at least one of a manufacturer of the terminal, a model name, a definition, CPU information, storage information, storing capacity, presence/absence of a touch screen, a serial number, a user, and an application history. Based on the user terminal information, the server 105 extracts the application executable at the terminal or the application designated for the terminal.

The server 105 determines network information which carries the request for the application list, extracts the optimized applications according to the determined network information, and provides the list of the extracted applications.

Herein, the network information is information relating to a data rate of the network which delivers the user terminal information. In other words, the network information is information relating to a data rate of the network to which the user terminal 100 and the server 100 are connected. Since the applications have various capacities, the low data rate of the network can be troublesome in the transmission of the large capacity application. Thus, the server 105 extracts the optimized applications based on the information of the network which carries the request for the application list, and provides the list of the extracted applications.

In this exemplary embodiment, WiFi 10-1 and a General Packet Radio Service (GPRS) 10-2 are exemplified to demonstrate two possible examples of the various types of networks in communication with the first terminal 100-1 and the second terminal 100-2. Note that the present disclosure can employ other various networks.

As such, the server 105 stores the applications created by the CP. When receiving the request for the application list from the terminal, the server 105 provides the list of the applications optimized for each terminal among the stored applications using the user terminal information and the network information.

In FIG. 5, as for the request for the application list of the first terminal 100-1 over the \textcircled{a}WiFi 10-1, the server 105 provides the application1 (App1) to the first terminal 100-1 over the WiFi 10-1. As for the request for the application list of the second terminal 100-2 over the \textcircled{b}WiFi 10-1, the server 105 provides the application2 (App2) to the second terminal 100-2 over the WiFi 10-1. As for the request for the application list of the first terminal 100-1 over the \textcircled{c}GPRS 10-2, the server 105 provides the application3 (App3) to the first terminal 100-1 over the GPRS 10-2. As for the request for the application list of the second terminal 100-2 over the \textcircled{d}GPRS 10-2, the server 105 provides the application4 (App4) to the second terminal 100-2 over the GPRS 10-2.

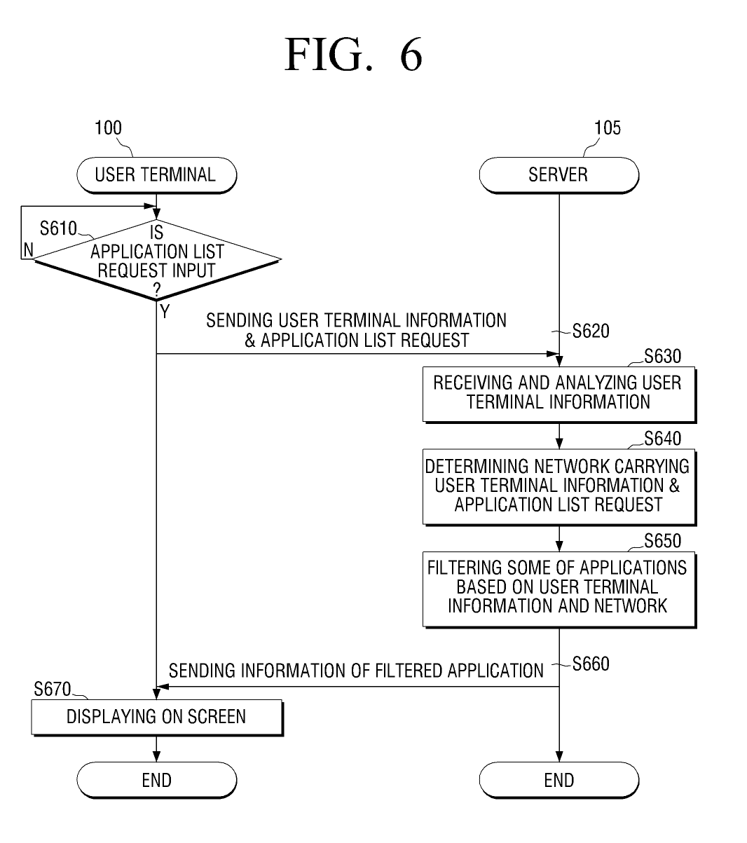

FIG. 6 is a flowchart of an application providing method according to an exemplary embodiment.

When receiving the request for the application list from the user (S610-Y), then at (S620) the user terminal 100 requests the application list from the server 105 and sends the information of the terminal (user terminal information) to the server 105.

At (S630), the server 105 analyzes the USER terminal information received from the user terminal 100 and at (S640) determines the reception path of the user terminal information and the application list request, that is, the network information. Based on the analyzed user terminal information from (S630) and the determined network information from (S640), the server 105 at (S650) filters some of the applications stored to the server 105, and, at (S660) the server 105 then transmits information of the filtered applications to the terminal 100. Herein, the information of the filtered applications indicates the filtered application list.

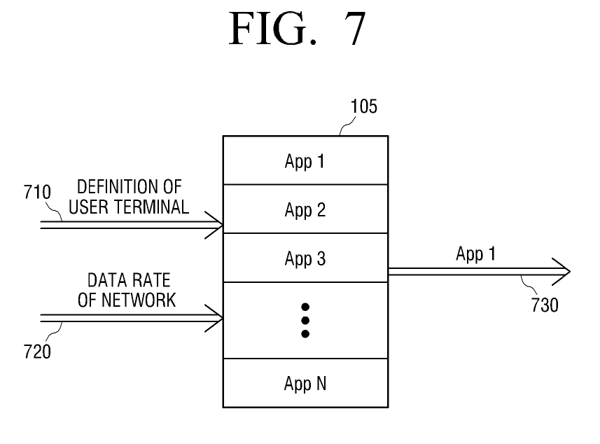

The application filtering will now be described with reference to FIG. 7. FIG. 7 depicts the application filtering process according to an exemplary process according to the present invention.

Upon receiving the user terminal information from the user terminal 100 and determining the network information, the server 200 extracts details of the user terminal 100, based on the user terminal information and the network information.

For example, when receiving the information of the manufacturer and the type of the terminal as the user terminal information, the server 105 can extract the details of the user terminal 100, such as the definition 710 of the user terminal 100, using the user terminal information as shown in FIG. 7. Likewise, the server 105 can extract the details of the network, such as the data rate 720 of the network. Such details may be pre-stored to the server 105.

Using the details such as the definition 710 of the terminal and the data rate 720 of the network, the server 105 extracts the list of the applications 730 to provide to the user terminal 100 from among the applications stored to the server 105, and the server 105 sends the list of the extracted applications to the user terminal 100.

Now referring back to FIG. 6, the user terminal 100 displays the application list received from the server 105 on a screen (S670) so that the user of the user terminal 100 can select his/her intended application from the application list.

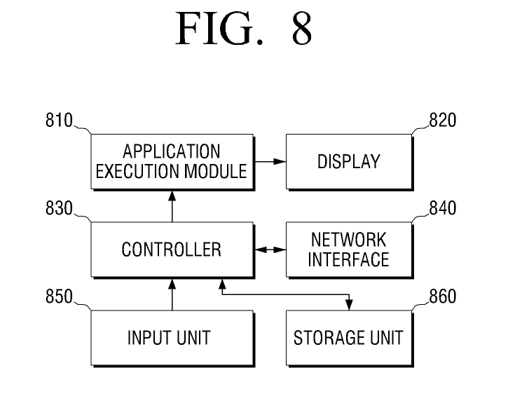

FIG. 8 is a block diagram of the aforementioned user terminal 100 discussed regarding FIGS. 5 to 7. The user terminal 100 includes an application execution module 810, a display 820, a controller 830, a network interface 840, an input part 850, and a storage unit 860.

The application execution module 810 image-processes the application list received from the server 105, controls the display of the application list on the screen, and controls the selection of one application of the application list and executes the application received from the server 105 at the user terminal 100. The application execution module 810 sends a signal to the display 820 to display the application list and the selected application on the screen. Accordingly, the display 820 displays the application list and the selected application on the screen.

The network interface 840 functions as a communication path of the user terminal 100 with the server 105 over the network. Through the network interface 840, the user terminal 100 sends the application list request, the user terminal information, and the request for the application to the server 105, and receives the application list and the selected application from the server 105.

The input unit 850 is connected to a mouse or a keyboard to receive a user's manipulation. In particular, the input unit 850 receives the user's command requesting the application list and the user's command requesting the application and forwards the received commands to the controller 830.

The storage unit 860 stores a program to operate the user terminal 100, various information, data, and applications received from the server 105. The storage unit 860 can be implemented using a hard disc, or some other type of a nonvolatile memory, etc.

The controller 830 controls the user terminal 100. More specifically, the controller 830 controls the sending of the application list request, the user terminal information, and the application request to the server 105 via the network interface 840, also controls displaying the application list received from the server 105 on the display 820, and controls execution of the application received from the server 105 at the user terminal 100.

In addition, the controller 830 selects one of the networks connected to the user terminal 100 so that the user terminal 100 can communicate with the server 105 over the selected network.

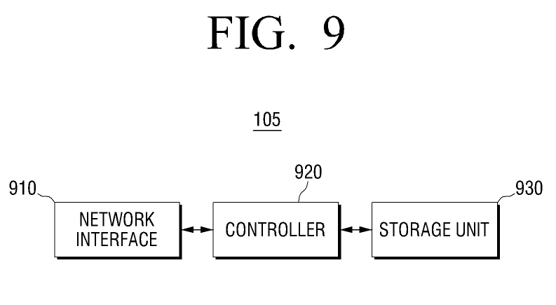

FIG. 9 is a block diagram of the server 105 mentioned above. The server 105 includes a network interface 910, a controller 920, and a storage unit 930.

The network interface 910 functions as a communication path of the server 105 with the user terminal 100 over the network. Through the network interface 910, the server 105 receives the application list request, the user terminal information, and the request for the application from the user terminal 100, and sends the application list and the application selected by the user to the user terminal 100.

The storage unit 930 stores a program to operate the server 105 and data such as applications received from the CP and contents. As the information relating to the applications received from the CP, the storage unit 930 stores information of the user terminal 100 capable of executing the application, information regarding the application capacity, and so forth. The storage 930 can be implemented using a hard disc, a nonvolatile memory, etc.

The controller 920 controls the server 105. More specifically, upon receiving the application list request and the user terminal information from the terminal 100 via the network interface 910, the controller 920 extracts the details of the user terminal 100 by analyzing the received user terminal information, determines the information of the network which is the reception path of the application list request and the user terminal information, and extracts the details of the network based on the determined information.

Based on the user terminal information and the network information, the controller 920 filters the applications optimized for the user terminal 100 from among the applications received from the CP and stored to the storage unit 930, and sends the list of the optimized applications to the user terminal 100.

As such, the server 105 can selectively provide the application applicable to the user terminal 100 to thus offer the convenience in the application use to the user.

Meanwhile, a person of ordinary skill in the art should understand and appreciate that while the first terminal 100-1 and the second terminal 100-2 are connected directly to the server 105 over the networks 10-1 and 10-2, this example has been provided merely for illustrative purposes and does not in any way limit the claimed invention. Notably, the first terminal 100-1 and the second terminal 100-2 can be connected to the server 105 over the networks 10-1 and 10-2 by means of a separate medium such as PC. For example, provided that the first terminal 100-1 is a mobile phone, when the mobile phone is connected to the PC and the application list is received from the server 105 over the networks 10-1 and 10-2 usable by the PC, the application selected from the application list can be provided to the mobile phone via the PC.

Although the user terminal in the above exemplary embodiment sends the user terminal information and the network information, the user terminal can send service provider information or user information additionally.

Herein, the service provider information is information relating to the application that can be provided by a service provider of the user terminal 100 (that is, the contents provider (CP)). The user information is information indicating details of use of an application service by a user of the user terminal 100, and includes at least one of an application buying history and application preference information of the user.

As described above, the user terminal 100 may send at least one of the user terminal information, the network information, the service provider information, and the user information to the server 105. In this case, the user terminal 100 may give priorities to the properties included in the at least one of the user terminal information, the network information, the service provider information, and the user information. Also, in order to give the priorities to the properties of the information, the user terminal 100 may add a flag indicating the priority given to the properties included in the at least one of the user terminal information, the network information, the service provider information, and the user information.

Also, the user terminal 100 may display the application list according to the properties included in the at least one of the user terminal information, the network information, the service provider information, and the user information. For example, the user terminal 100 may display only the application list corresponding to the user terminal information on the screen. Also, the user terminal 100 may display the application list corresponding to the service provider information and the application list corresponding to the user information on separate areas separately.

Accordingly, the server 105 receives the at least one of the user terminal information, the network information, the service provider information, and the user information from the user terminal 100. Based on the at least one of the user terminal information, the network information, the service provider information, and the user information, the server 105 extract at least one application from the pre-stored applications. The server 105 generates an application list using the extracted application and sends the application list to the user terminal 100.

More specifically, using the user terminal information, the network information, the service provider information, and the user information, the server 105 extracts at least one application corresponding to each of the aforementioned information as follows:

Based on the user terminal information, the server 105 may extract at least one application executable at the user terminal 100 from the pre-stored applications. For example, the server 105 may recognize a screen definition of the user terminal 100 based on the user terminal information and generate an application list by extracting the applications executable at the screen definition of the user terminal 100.

Also, based on the network information, the server 105 may extract at least one application downloadable within a specific time according to the data rate of the network. For example, based on the network information, the server 105 may generate an application list by extracting applications of capacities that can be downloaded within five minutes.

Also, based on the service provider information, the server 105 may extract at least one application that can be provided by a service provider of the user terminal. For example, the server 105 may generate an application list by extracting applications that can be provided by You Tube.

Also, based on the user information, the server 105 may extract at least one application according to a user's busying history and user's preference. For example, the server 105 may generate an application list by extracting applications except for the applications the user have bought previously.

The sever 105 may store a user's buying history and user's preference for each user. The server 105 updates the user's buying history and the user's preference information whenever the user buys an application or inputs preference information. Accordingly, the server 105 can extract at least one application according to user's buying history and preference currently stored in the user terminal 100.

Also, the server 105 may change at least one of a condition for the user terminal information, a condition for the network information, and a condition for the service provider information for extracting an application.

The condition for the user terminal information preferably indicates an internal condition for the server 105 to extract an application according to the user terminal information received from the user terminal 100.

The condition for the network information preferably indicates an internal condition for the server 105 to extract an application according to the network information received from the user terminal 100.

The condition for the service provider information preferably indicates an internal condition for the server 105 to extract an application according to the service provider information received from the user terminal 100.

As described above, the server 105 may change the internal condition to extract the application and extract the application suitable for the changed condition.

As described above, the user terminal 100 can send at least one of the user terminal information, the network information, the service provider information, and the user information to the server 105. The server 105 generates the application list according to the request from the user terminal using the at least one of the user terminal information, the network information, the service provider information, and the user information. Accordingly, the user terminal 100 can receive the application list suitable for the user terminal 100 from the server 105.

It should be understood that any user terminal that can download an application may be applied as the user terminal 100. For example, the user terminal 100 may be an MP3 player, a portable multimedia player (PMP), a mobile phone, or a personal digital assistant (PDA).

The above-described methods according to the present invention can be realized in hardware or as software or computer code that can be stored in a recording medium such as a CD ROM, a RAM, thumbnail drive, a floppy disk, a flash storage, a hard disk, or a magneto-optical disk or downloaded over a network and stored, so that the methods described herein can be executed by such software using a general purpose computer, or a special processor or in programmable or dedicated hardware, such as an ASIC or FPGA. As would be understood in the art, the computer, the processor or the programmable hardware include memory components, e.g., RAM, ROM, Flash, etc. that may store or receive software or computer code that when accessed and executed by the computer, processor or hardware implement the processing methods described herein. In addition, it would be recognized that when a general purpose computer accesses code for implementing the processing shown herein, the execution of the code transforms the general purpose computer into a special purpose computer for executing the processing shown herein.

Although a few exemplary embodiments of the present invention have been shown and described, it would be appreciated by those skilled in the art that changes may be made in these exemplary embodiments without departing from the principles and spirit of the invention, the scope of which is defined in the claims and their equivalents.

What is claimed is:

1. An application downloading method of a user terminal which downloads an application from a server, the method comprising:
sending by a user terminal at least one of user terminal information, network information, service provider information, and user information to the server;
receiving from the server an application list which is generated based on the at least one of the user terminal information, the network information, the service provider information, and the user information; and
displaying the received application list on a screen of the user terminal.

2. The application downloading method of claim 1, wherein the user terminal information comprises at least one of a manufacturer, a model name, a definition, CPU information, storage information, storing capacity, and information of presence/absence of a touch screen of the user terminal.

3. The application downloading method of claim 1, wherein the network information comprises information relating to a data rate of a network connected between the user terminal and the server.

4. The application downloading method of claim 1, wherein the service provider information comprises information relating to an application that is provided by a service provider of the user terminal.

5. The application downloading method of claim 1, wherein the user information comprises at least one of a purchasing history of a user of the user terminal and preference information of the user.

6. The application downloading method of claim 1, wherein the sending by the user terminal includes providing priorities to properties included in the at least one of the user terminal information, the network information, the service provider information, and the user information.

7. The application downloading method of claim 6, wherein the sending by the user terminal comprises adding flags representing priorities to properties included in the at least one of the user terminal information, the network information, the service provider information, and the user information.

8. The application downloading method of claim 1, wherein the displaying by the user terminal comprises displaying the application list on a display screen according to properties included in the at least one of the user terminal information, the network information, the service provider information, and the user information.

9. A user terminal which downloads an application from a server, comprising:
a network interface for accessing the server over one of a plurality of networks;
a display unit for displaying an image; and
a controller for controlling the network interface to send at least one of user terminal information, network information, service provider information, and user information to the server and for receiving an application list which is generated based on the at least one of the user terminal information, the network information, the service provider information, and the user information, and for controlling display of the application list on a display screen.

10. The user terminal of claim 9, wherein the user terminal information comprises at least one of a manufacturer, a model name, a definition, CPU information, storage information, storage capacity, and information relating to presence/absence of a touch screen of the user terminal.

11. The user terminal of claim 9, wherein the network information comprises information relating to a data rate of a network connected between the user terminal and the server.

12. The user terminal of claim 9, wherein the service provider information comprises information relating to an application that is provided by a service provider of the user terminal.

13. The user terminal of claim 9, wherein the user information comprises at least one of a purchasing history of a user of the user terminal and preference information of the user.

14. The user terminal of claim 9, wherein the controller controls giving priorities to properties included in the at least one of the user terminal information, the network information, the service provider information, and the user information, and for sending the at least one information.

15. The user terminal of claim 14, wherein the controller controls adding flags representing priorities of properties included in the at least one of the user terminal information, the network information, the service provider information, and the user information, and sending the at least one information.

16. The user terminal of claim 9, wherein the controller controls displaying the application list on the screen according to properties included in the at least one of the user terminal information, the network information, the service provider information, and the user information.

17. An application providing method of a server which provides an application to a user terminal, the method comprising:
receiving at least one of user terminal information, network information, service provider information, and user information from a user terminal;
extracting from storage at least one application from pre-stored applications, based on the at least one of the user terminal information, the network information, the service provider information, and the user information; and
generating an application list using the extracted application and sending the application list to the user terminal.

18. The application providing method of claim 17, wherein the extracting comprises extracting at least one application executable at the user terminal from the pre-stored applications based on the user terminal information previously provided.

19. The application providing method of claim 17, wherein the extracting comprises extracting at least one application downloadable within a specific time according to a data rate of the network based on the network information.

20. The application providing method of claim 17, wherein the extracting comprises extracting at least one application provided by a service provider of the user terminal based on the service provider information.

21. The application providing method of claim 17, wherein the extracting comprises extracting at least one application according to a purchasing history and preference of the user based on the user information.

22. The application providing method of claim 21, further comprising storing the purchasing history and the preference of the user,
wherein the extracting comprises extracting at least one application according to the stored purchasing history and preference of the user.

23. The application providing method of claim 17, further comprising changing at least one of a condition for the user terminal information, a condition for the network information, and a condition for the service provider information to extract an application in the extracting operation.

24. A server which provides an application to a user terminal, comprising:
a network interface for accessing a user terminal over one of a plurality of networks; and
a controller for controlling the network interface to receive at least one of user terminal information, network information, service provider information, and user information, extract at least one application from stored applications based on the at least one of the user terminal information, the network information, the service provider information, and the user information, generate an application list using the extracted application, and send the application list to the user terminal.

25. The server of claim 24, wherein the controller extracts at least one application executable by the user terminal from the stored applications based on the user terminal information.

26. The server of claim 24, wherein the controller extracts at least one application downloadable within a specific time according to a data rate of the network based on the network information.

27. The server of claim 24, wherein the controller extracts at least one application that is provided by a service provider of the user terminal based on the service provider information.

28. The server of claim 24, wherein the controller extracts at least one application according to a purchasing history and preference of the user based on the user information.

29. The server of claim 28, further comprising a data base unit for storing the purchasing history and the preference of the user,
wherein the controller extracts at least one application according to the stored purchasing history and preference of the user.

30. The server of claim 24, further comprising a storage unit for storing at least one of a condition for the user terminal information, a condition for the network information, and a condition for the service provider information to extract an application,
wherein the controller changes at least one of the condition for the user terminal information, the condition for the network information, and the condition for the service provider information.
